(19) United States
(12) Patent Application Publication
(10) Pub. No.: US 2023/0312824 A1
(43) Pub. Date: Oct. 5, 2023

(54) CURABLE COMPOSITION, HEAT STORAGE MATERIAL, AND ARTICLE

(71) Applicant: Resonac Corporation, Tokyo (JP)

(72) Inventors: Tsuyoshi MORIMOTO, Tokyo (JP); Naoki FURUKAWA, Tokyo (JP); Hiroshi YOKOTA, Tokyo (JP)

(21) Appl. No.: 18/023,151

(22) PCT Filed: Jul. 19, 2021
(86) PCT No.: PCT/JP2021/026993

§ 371 Date: Feb. 24, 2023

(30) Foreign Application Priority Data
Aug. 28, 2020 (JP) 2020-144374

(51) Int. Cl. C08G 65/48; C08J 7/18

(52) U.S. Cl. CPC C08G 65/48; C08J 7/18; C08G 2150/00; C08G 2650/40; C08J 2371/08

(57) ABSTRACT

A curable composition containing: a compound represented by the following formula (1):

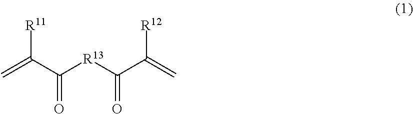

wherein R¹¹ and R¹² each independently represent a hydrogen atom or a methyl group, and R¹³ represents a divalent group having a polyoxyalkylene chain; and at least one polyalkylene glycol ether selected from the group consisting of a polyalkylene glycol monoether and a polyalkylene glycol diether.

### TECHNICAL FIELD

The present invention relates to a curable composition, a heat storage material, and an article.

### BACKGROUND ART

A heat storage material is a material from which stored energy can be extracted as heat as necessary. A heat storage material is used for applications such as, for example, electronic components such as in an air conditioning device, a floor heating device, a refrigerator, and an IC chip, automobile components such as in automobile interior and exterior materials, a canister, and an insulation container.

Regarding a heat storage method, a latent heat type heat storage using a phase change in a substance is widely used in consideration of the amount of heat. For example, Patent Document 1 discloses a heat storage material composition containing a polyalkylene glycol as a latent heat type heat storage component.

### CITATION LIST

### Patent Document

[Patent Document 1] Japanese Patent Laid-Open No. 2006-96898

### SUMMARY OF INVENTION

### Technical Problem

According to studies by the present inventors, a heat storage material containing a polyalkylene glycol has room for further improvement in terms of reliability under a high-temperature and high-humidity environment. Therefore, in one aspect, an object of the present invention is to provide a curable composition capable of forming a heat storage material having excellent reliability under a high-temperature and high-humidity environment.

### Solution to Problem

As a result of intensive studies, the present inventors have found that a heat storage material having excellent reliability in a high-temperature and high-humidity environment can be formed by using a specific compound having a polyoxyalkylene chain and two (meth)acryloyl groups in combination with a compound obtained by etherifying a hydroxyl group at at least one terminal of a polyalkylene glycol, and have completed the present invention. In some aspects, the present invention provides the following [1] to [8].

[1] A curable composition comprising:
a compound represented by the following formula (1):

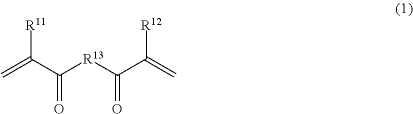

wherein R¹¹ and R¹² each independently represent a hydrogen atom or a methyl group, and Rn represents a divalent group having a polyoxyalkylene chain; and
at least one polyalkylene glycol ether selected from the group consisting of a polyalkylene glycol monoether and a polyalkylene glycol diether.

[2] The curable composition according to [1], comprising a compound having a weight average molecular weight of 1,000 or more and represented by the formula (1), as the compound represented by the formula (1).

[3] The curable composition according to [1] or [2], comprising a polyalkylene glycol ether having a weight average molecular weight of 400 or more as the polyalkylene glycol ether.

[4] The curable composition according to any one of [1] to [3], comprising a polyalkylene glycol ether having a weight average molecular weight of 5,000 or less as the polyalkylene glycol ether.

[5] The curable composition according to any one of [1] to [4], further comprising a compound represented by the following formula (3):

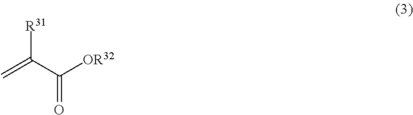

wherein R³¹ represents a hydrogen atom or a methyl group, and R³² represents a monovalent group having a polyoxyalkylene chain.

[6] The curable composition according to any one of [1] to [5], being used for forming a heat storage material.

[7] A heat storage material comprising a cured product of the curable composition according to any one of [1] to [6].

[8] An article comprising:
a heat source; and
a cured product of the curable composition according to any one of [1] to [6], the cured product being provided to be thermally in contact with the heat source.

### Advantageous Effects of Invention

According to an aspect of the present invention, it is possible to provide a curable composition that can form a heat storage material having an excellent heat storage capacity.

### BRIEF DESCRIPTION OF DRAWINGS

FIG. 1 is a schematic cross-sectional view showing a heat storage material according to one embodiment.

FIG. 2 is a schematic cross-sectional view showing an article and a method of producing the same according to one embodiment.

FIG. 3 is a schematic cross-sectional view showing an article according to another embodiment.

FIG. 4 is a schematic cross-sectional view showing a method of producing an article according to another embodiment.

### DESCRIPTION OF EMBODIMENTS

Embodiments of the present invention will be appropriately described below in detail with reference to the drawings. Here, the present invention is not limited to the following embodiment.

In this specification, “(meth)acrylol” means “acryloyl” and its corresponding “methacryloyl” and the same applies to similar expressions such as “(meth)acrylate” and “(meth)acrylic.”

The weight average molecular weight (Mw) in this specification is a value which is measured using gel permeation chromatography (GPC) under the following conditions and determined using a polystyrene as a standard substance.
Measurement instrument: HLC-8320GPC (product name, manufactured by Tosoh Corporation)
Analysis column: TSKgel SuperMultipore HZ-H (3 columns connected) (product name, manufactured by Tosoh Corporation)
Guard column: TSKguardcolumn SuperMP(HZ)-H (product name, manufactured by Tosoh Corporation)
Eluent: THF
Measurement temperature: 25° C.

[Curable Composition]

A curable composition according to one embodiment contains a compound represented by the following formula (1):

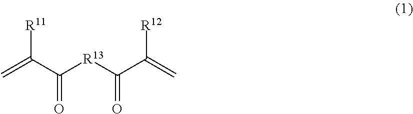

wherein R¹¹ and R¹² each independently represent a hydrogen atom or a methyl group, and Rn represents a divalent group having a polyoxyalkylene chain, and at least one polyalkylene glycol ether selected from the group consisting of polyalkylene glycol monoethers and polyalkylene glycol diethers.

In one embodiment, one of R¹¹ and R¹² may be a hydrogen atom and the other may be a methyl group, in another embodiment, both R¹¹ and R¹² may be hydrogen atoms, and in another embodiment, both R¹¹ and R¹² may be methyl groups.

The polyoxyalkylene chain is represented by, for example, the following the formula (1-1):

*—(R¹⁴O)ₘ—*(1-1)

wherein R¹⁴ represents an alkylene group, in represents an integer of 2 or more, and * represents a bond.

The alkylene group represented by R¹⁴ may be linear or branched. R¹⁴ may be, for example, an alkylene group having 2 to 4 carbon atoms. A plurality of R¹⁴'s in the polyoxyalkylene chain may be the same as or different from each other. The plurality of R¹⁴'s in the polyoxyalkylene chain are preferably one or two or more selected from the group consisting of an ethylene group, a propylene group and a butylene group, more preferably one or two selected from the group consisting of an ethylene group and a propylene group, and still more preferably, all of them are ethylene groups.

m may be, for example, an integer of 10 or more or 20 or more, and may be an integer of 300 or less, 250 or less, or 200 or less. m may be an integer such that the molecular weight of the compound represented by the formula (1) is, for example, 1,000 or more, and from the viewpoint of obtaining a heat storage material having more excellent reliability in a high-temperature and high-humidity environment, in is preferably an integer such that the molecular weight of the compound represented by the formula (1) is 2,000 or more, 3,000 or more, 4,000 or more, 5,000 or more, 6,000 or more, or 7,000 or more. m is an integer such that the molecular weight of the compound represented by the formula (1) is preferably 12,000 or less, 11,000 or less, 10,000 or less, 9,000 or less, 8,000 or less, 7,000 or less, 6,000 or less, 5,000 or less, 4,000 or less, 3,000 or less, or 2,000 or less, from the viewpoint of suppressing a decrease in heat storage characteristics due to supercooling.

Rn may be a divalent group that further includes other organic groups in addition to the polyoxyalkylene chain. The other organic group may be a chain-like group other than the polyoxyalkylene chain, and may be, for example, a methylene chain (a chain having —CH₂— as a structural unit), a polyester chain (a chain having —COO— in a structural unit), or a polyurethane chain (a chain having —OCON— in a structural unit).

The compound represented by the formula (1) is preferably a compound represented by the following the formula (1-2):

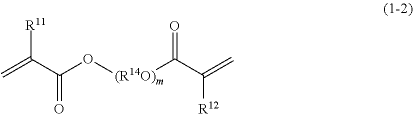

wherein R¹¹ and R¹² are the same as R¹¹ and R¹² in the formula (1), and R¹⁴ and in are the same as R¹⁴ and in in the formula (1-1).

The weight average molecular weight (Mw) of the compound represented by the formula (1) may be, for example, 1,000 or more, and is preferably 2,000 or more, 3,000 or more, 4,000 or more, 5,000 or more, 6,000 or more, or 7,000 or more, from the viewpoint of obtaining a heat storage material having more excellent reliability in a high-temperature and high-humidity environment. The weight average molecular weight (Mw) of the compound represented by the formula (1) is preferably 12,000 or less, 11,000 or less, 10,000 or less, 9,000 or less, 8,000 or less, 7,000 or less, 6,000 or less, 5,000 or less, 4,000 or less, 3,000 or less, or 2,000 or less, from the viewpoint of suppressing a decrease in heat storage characteristics due to supercooling.

The curable composition may contain one compound represented by the formula (1) having the above Mw or may contain two or more compounds represented by the formula (1) having different Mws from each other. In the latter case, when the Mw of the compound represented by the formula (1) is measured by the above method, in the obtained molecular weight distribution, two or more peaks corresponding to respective Mws of two or more compounds represented by the formula (1) are observed.

In one embodiment, from the viewpoint of obtaining a heat storage material having more excellent heat storage capacity, the curable composition may preferably contain at least one compound (referred to as a compound (1A)) having an Mw of 2,000 or more or may contain at least one compound (1A) and at least one compound represented by the formula (1) (referred to as a compound (1B)) having an Mw of less than 2,000. The Mw of the compound (1A) is more preferably 3,000 or more, 4,000 or more, 5,000 or more, 6,000 or more, or 7,000 or more, and may be, for example, 12,000 or less, 11,000 or less, or 10,000 or less. The Mw of the compound (1B) may be, for example, 1,000 or more, or 1,500 or less.

The content of the compound represented by the formula (1), based on the total amount of the curable composition, may be, for example, 1% by mass or more, 2% by mass or more, or 5% by mass or more, and from the viewpoint of obtaining excellent flexibility of a cured product of the curable composition and obtaining a heat storage material having further excellent heat storage capacity, is preferably 10% by mass or more, 15% by mass or more, or 20% by mass or more, and more preferably 25% by mass or more, 30% by mass or more, 35% by mass or more, or 40% by mass or more. Here, when a cured product of the curable composition has excellent flexibility, for example, since the cured product that is bent can be used, the cured product is more suitable as a heat storage material that can be applied in a wider range of applications. The content of the compound represented by the formula (1) may be, for example, 99% by mass or less, 90% by mass or less, 80% by mass or less, 70% by mass or less, 60% by mass or less, or 50% by mass or less, based on the total amount of the curable composition. When the curable composition contains two or more compounds represented by the formula (1), the total amount thereof may be in the above range. When the curable composition contains the compound (1A) and/or the compound (1B), the total amount of the compound (1A) and the compound (1B) may be in the above range, or the content of each of the compound (1A) and the compound (1B) may be in the above range.

When the curable composition further contains a compound copolymerizable with the compound represented by the formula (1) in addition to the compound represented by the formula (1) (details will be described below), the content of the compound represented by the formula (1) may be 1 part by mass or more, 2 parts by mass or more, or 5 parts by mass or more, with respect to 100 parts by mass of total of the content of the compound represented by the formula (1) and the content of the compound copolymerizable with the compound represented by the formula (1) (hereinafter referred to as “total content of the polymerizable components”), and from the viewpoint of obtaining excellent flexibility of a cured product of the curable composition and obtain a heat storage material having more excellent heat storage capacity, the content is preferably 10 parts by mass or more or 15 parts by mass or more, more preferably 20 parts by mass or more, 25 parts by mass or more, 30 parts by mass or more, or 35 parts by mass or more, and still more preferably 40 parts by mass or more. The content of the compound represented by the formula (1) may be, for example, 99 parts by mass or less, 90 parts by mass or less, 80 parts by mass or less, 70 parts by mass or less, 60 parts by mass or less, or 50 parts by mass or less, with respect to 100 parts by mass of the total content of the polymerizable components.

The polyalkylene glycol ether is represented by, for example, the following formula (2):

R²¹—O—(R²³O)ₙ—R²² (2)

wherein R²¹ and R²² each independently represent a hydrogen atom or a monovalent hydrocarbon group, R²³ represents an alkylene group, and n represents an integer of 2 or more. At least one of R²¹ and R²² represents a monovalent hydrocarbon group. When only one of R²¹ and R²² is a monovalent hydrocarbon group, the polyalkylene glycol ether is a polyalkylene glycol monoether. When both R²¹ and R²² are monovalent hydrocarbon groups, the polyalkylene glycol ether is a polyalkylene glycol diether.

The monovalent hydrocarbon group represented by R²¹ and R²² may be, for example, an alkyl group or an aryl group, and is preferably an alkyl group. The alkyl group may be linear or branched. The number of carbon atoms of the alkyl group may be, for example, 1 or more, and may be 10 or less, 8 or less, 6 or less, 4 or less, or 2 or less. Examples of the aryl group include a phenyl group.

The alkylene group represented by R²³ may be linear or branched, and is preferably linear from the viewpoint of obtaining a heat storage material having more excellent heat storage amount. The R²³ may be, for example, an alkylene group having 2 to 4 carbon atoms. A plurality of R²³ may be the same as or different from each other. All of the plurality of R²³ present in one molecular are preferably ethylene groups.

In one embodiment, it is preferable that the monovalent hydrocarbon groups represented by R²¹ and R²² are alkyl groups, and the alkylene groups represented by R²³ are all ethylene groups. That is, the polyalkylene glycol ether is preferably at least one selected from the group consisting of a polyethylene glycol monoalkyl ether and a polyethylene glycol dialkyl ether.

n may be, for example, an integer of 10 or more or 20 or more, and may be an integer of 100 or less, 90 or less, 80 or less, 70 or less, or 60 or less. n may be, for example, an integer such that the molecular weight of the compound represented by the formula (2) is 400 or more, 500 or more, 600 or more, 700 or more, 800 or more, 900 or more, or 1000 or more. n is an integer such that the molecular weight of the compound represented by the formula (2) is preferably 5,000 or less, 4,000 or less, 3,000 or less, or 2,500 or less, from the viewpoint of further increasing the effect of improving reliability under a high-temperature and high-humidity environment by etherifying the terminal hydroxyl group of the polyalkylene glycol.

The weight average molecular weight (Mw) of the compound represented by the formula (2) may be, for example, 500 or more, 600 or more, 700 or more, 800 or more, 900 or more, or 1000 or more. The weight average molecular weight (Mw) of the compound represented by the formula (2) is preferably 5,000 or less, 4,000 or less, 3,000 or less, or 2,500 or less, from the viewpoint of further increasing the effect of improving reliability under a high-temperature and high-humidity environment by etherifying the terminal hydroxyl group of the polyalkylene glycol.

The content of the polyalkylene glycol ether, based on the total amount of the curable composition, may be, for example, 10% by mass or more, and from the viewpoint of obtaining a heat storage material having a more excellent heat storage amount, is preferably 15% by mass or more, 20% by mass or more, 25% by mass or more, 30% by mass or more, 35% by mass or more, or 40% by mass or more. The content of the polyalkylene glycol ether may be, for example, 80% by mass or less, 70% by mass or less, 65% by mass or less, or 60% by mass or less, based on the total amount of the curable composition.

The content of the polyalkylene glycol ether, with respect to 100 parts by mass of the total content of the polymerizable components, may be 10 parts by mass or more, 20 parts by mass or more, or 30 parts by mass or more, and from the viewpoint of obtaining a heat storage material having a more excellent heat storage capacity, is preferably 40 parts by mass or more, more preferably 50 parts by mass or more, and even more preferably 60 parts by mass or more, and may be 70 parts by mass or more, 80 parts by mass or more, 90 parts by mass or more, or 100 parts by mass or more. The content of the polyalkylene glycol may be 500 parts by mass or less, 400 parts by mass or less, 300 parts by mass or less, 200 parts by mass or less, 150 parts by mass or less, 120 parts by mass or less, 110 parts by mass or less, or 100 parts by mass or less, with respect to 100 parts by mass of the total content of the polymerizable components.

The curable composition may further contain a polymerization initiator. The polymerization initiator is not particularly limited as long as it is a compound that can initiate polymerization of the compound represented by the formula (1) and the compound copolymerizable with the compound represented by the formula (1) used as necessary (details will be described below). The polymerization initiator may be, for example, a thermal polymerization initiator that causes radicals to be generated by heat or a photopolymerization initiator that causes radicals to be generated by light.

When the curable composition contains a thermal polymerization initiator, a cured product of the curable composition can be obtained by applying heat to the curable composition. In this case, the curable composition may be a curable composition that is cured by heating at preferably 105° C. or higher, more preferably 110° C. or higher, and still more preferably 115° C. or higher, and may be, for example, a curable composition that is cured by heating at 200° C. or lower, 190° C. or lower, or 180° C. or lower. The heating time for which the curable composition is heated may be appropriately selected according to the composition of the curable composition so that the curable composition is suitably cured.

Examples of thermal polymerization initiators include azo compounds such as azobisisobutyronitrile, azobis-4-methoxy-2,4-dimethylvaleronitrile, azobiscyclohexanone-1-carbonitrile, and azodibenzoyl, and organic peroxides such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane, and t-butylperoxyisopropyl carbonate. These thermal polymerization initiators may be used alone or two or more thereof may be used in combination.

When the curable composition contains a photopolymerization initiator, for example, a cured product of the curable composition can be obtained by emitting light (for example, light having at least a part of wavelengths of 200 to 400 nm (ultraviolet light)) to the curable composition. Light emission conditions may be appropriately set according to the type of photopolymerization initiator.

Examples of photopolymerization initiators include a benzoin ether photopolymerization initiator, an acetophenone photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenone photopolymerization initiator, a ketal photopolymerization initiator, a thioxanthone photopolymerization initiator, and an acylphosphine oxide photopolymerization initiator.

Examples of benzoin ether photopolymerization initiators include benzoin methyl ether, benzoin ethyl ether, benzoin propyl ether, benzoin isopropyl ether, benzoin isobutyl ether, 2,2-dimethoxy-1,2-diphenylethane-1-one (product name: Omnirad 651, manufactured by IGM Resins B.V.), and anisole methyl ether. Examples of acetophenone photopolymerization initiators include 1-hydroxycyclohexylphenyl ketone (product name: Omnirad 184, manufactured by IGM Resins B.V.), 4-phenoxydichloroacetophenone, 4-t-butyl-dichloroacetophenone, 1-[4-(2-hydroxyethoxy)-phenyl]-2-hydroxy-2-methyl-1-propan-1-one (product name: Omnirad 2959, manufactured by IGM Resins B.V.), 2-hydroxy-2-methyl-1-phenyl-propan-1-one (product name: Omnirad 1173, manufactured by IGM Resins B.V.), and methoxy acetophenone.

Examples of α-ketol photopolymerization initiators include 2-methyl-2-hydroxypropiophenone, and 1-[4-(2-hydroxyethyl)-phenyl]-2-hydroxy-2-methylpropan-1-one. Examples of aromatic sulfonyl chloride photopolymerization initiators include 2-naphthalenesulfonyl chloride. Examples of photoactive oxime photopolymerization initiators include 1-phenyl-1,1-propanedione-2-(o-ethoxycarbonyl)-oxime.

Examples of benzoin photopolymerization initiators include benzoin. Examples of benzyl photopolymerization initiators include benzyl. Examples of benzophenone photopolymerization initiators include benzophenone, benzoyl benzoic acid, 3,3′-dimethyl-4-methoxybenzophenone, polyvinylbenzophenone, and α-hydroxycyclohexylphenyl ketone. Examples of ketal photopolymerization initiators include benzyl dimethyl ketal. Examples of thioxanthone photopolymerization initiators include thioxanthone, 2-chlorothioxanthone, 2-methylthioxanthone, 2,4-dimethyl thioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Examples of acylphosphin photopolymerization initiators include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzyl butylphosphine oxide, 2,6-dimethoxybenzoyl benzyl octylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethtoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The above photopolymerization initiators may be used alone or two or more thereof may be used in combination.

From the viewpoint of allowing the polymerization to proceed favorably, the content of the polymerization initiator, with respect to 100 parts by mass of the total content of the polymerizable components, is preferably 0.01 parts by mass or more, more preferably 0.02 parts by mass or more, and still more preferably 0.05 parts by mass or more. From the viewpoint of setting the molecular weight of the polymer in the cured product of the curable composition to be within a suitable range, reducing a decomposition product, and obtaining a suitable adhesive strength when it is used as a heat storage material, the content of the polymerization initiator, with respect to 100 parts by mass of the total content of the polymerizable components, is preferably 10 parts by mass or less, more preferably 5 parts by mass or less, still more preferably 3 parts by mass or less, and particularly preferably 1 part by mass or less.

The curable composition may further contain a compound copolymerizable with the compound represented by the formula (1). The copolymerizable compound has, for example, a group having an ethylenically unsaturated bond (ethylenically unsaturated group). Examples of ethylenically unsaturated groups include a (meth)acryloyl group, a vinyl group, and an allyl group. The copolymerizable compound is preferably a compound having a (meth)acryloyl group.

From the viewpoint of obtaining a heat storage material having more excellent heat storage capacity, preferably, the curable composition further contains, as the copolymerizable compound, a compound represented by the following the formula (3):

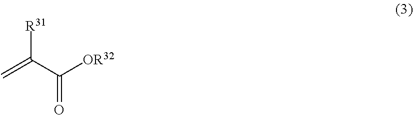

wherein R³¹ represents a hydrogen atom or a methyl group, and R³² represents a monovalent group having a polyoxyalkylene chain.

R³² may be, for example, a group represented by the following the formula (3-1):

*—(R³³O)ₚ—R³⁴ (3-1)

wherein R³³ represents an alkylene group, R³⁴ represents a hydrogen atom or an alkyl group, p represents an integer of 2 or more, and * represents a bond.

The alkylene group represented by R³³ may be linear or branched, and is preferably linear from the viewpoint of obtaining a heat storage material having a more excellent heat storage amount. R³³ may be, for example, an alkylene group having 2 to 4 carbon atoms. A plurality of R³³'s in the polyoxyalkylene chain may be the same as or different from each other. The polyoxyalkylene chain preferably has one or two or more selected from the group consisting of oxyethylene groups, oxypropylene groups and oxybutylene groups, more preferably one or two selected from the group consisting of oxyethylene groups and oxypropylene groups, and still more preferably has only an oxyethylene group.

The alkyl group represented by R³⁴ may be linear or branched, and is preferably linear from the viewpoint of obtaining a heat storage material having a more excellent heat storage amount. The number of carbon atoms of the alkyl group is preferably 1 to 15, more preferably 1 to 10, and still more preferably 1 to 5. R³⁴ is particularly preferably a hydrogen atom or a methyl group.

p may be, for example, an integer of 10 or more or 20 or more, and may be an integer of 80 or less, 70 or less, or 60 or less. From the viewpoint of obtaining a heat storage material having more excellent heat storage capacity, p may be an integer such that the molecular weight of the compound represented by the formula (3) is preferably 800 or more, 900 or more, or 1,000 or more, and more preferably 1,200 or more, 1,400 or more, 1,600 or more, 1,800 or more, or 2,000 or more. p may be an integer such that the molecular weight of the compound represented by the formula (3) is 5,000 or less, 4,000 or less, 3,000 or less, or 2,500 or less.

From the viewpoint of obtaining a heat storage material having more excellent heat storage capacity, the weight average molecular weight (Mw) of the compound represented by the formula (3) is preferably 800 or more, 900 or more, or 1,000 or more, and more preferably 1,200 or more, 1,400 or more, 1,600 or more, 1,800 or more, or 2,000 or more. The weight average molecular weight (Mw) of the compound represented by the formula (3) may be 5,000 or less, 4,000 or less, 3,000 or less, or 2,500 or less.

The content of the compound represented by the formula (3), with respect to 100 parts by mass of the total content of the polymerizable components, may be, for example, 10 parts by mass or more, 20 parts by mass or more, or 30 parts by mass or more, and from the viewpoint of obtaining a heat storage material having more excellent heat storage capacity, is preferably 40 parts by mass or more, more preferably 50 parts by mass or more, still more preferably 60 parts by mass or more, and particularly preferably 70 parts by mass or more. The content of the compound represented by the formula (3), with respect to 100 parts by mass of the total content of the polymerizable components, may be, for example, 98 parts by mass or less, 90 parts by mass or less, or 80 parts by mass or less.

In the case where the curable composition contains the compound represented by the formula (3), from the viewpoint that the cured product of the curable composition can be suitably used as a heat storage material, the melting point of the compound represented by the formula (3) is preferably close to the melting point of the polyalkylene glycol ether. The absolute value of the difference between the melting point of the compound represented by the formula (3) and the melting point of the polyalkylene glycol ether is preferably 20° C. or less, more preferably 15° C. or less, and still more preferably 10° C. or less.

The melting point of the compound represented by the formula (3) and the melting point of the polyalkylene glycol ether are measured as follows. Using a differential scanning calorimeter (for example, manufactured by TA Instruments, model number Discovery DSC250), the temperature is raised to 100° C. at a rate of 20° C./min, held at 100° C. for 3 minutes, then lowered to −20° C. at a rate of 3° C./min, held at −20° C. for 3 minutes, and then raised again to 100° C. at a rate of 3° C./min.

From the viewpoint of adjusting the hardness of the cured product of the curable composition and easily dissolving the polymerization initiator in the curable composition when the polymerization initiator is a solid, the curable composition may further contain, as the compound copolymerizable with the compound represented by the formula (1), a compound represented by the following the formula (4):

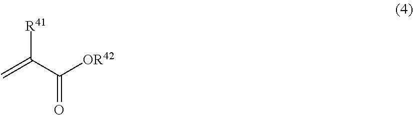

wherein R⁴¹ represents a hydrogen atom or a methyl group, and R⁴² represents an alkyl group.

The alkyl group represented by R⁴² may be linear or branched, and is preferably linear from the viewpoint of obtaining a heat storage material having a more excellent heat storage amount. The number of carbon atoms of the alkyl group may be, for example, 1 to 30. The number of carbon atoms of the alkyl group may be 1 to 11, 1 to 8, 1 to 6, or 1 to 4, or may be 12 to 30, 12 to 28, 12 to 24, 12 to 22, 12 to 18, or 12 to 14.

The content of the compound represented by the formula (4), with respect to 100 parts by mass of the total content of the polymerizable components, may be, for example, 0.5 parts by mass or more, 1 part by mass or more, or 1.5 parts by mass or more, and may be 10 parts by mass or less, 8 parts by mass or less, or 6 parts by mass or less.

The curable composition may further contain, as the compound copolymerizable with the compound represented by the formula (1), a compound represented by the following the formula (5):

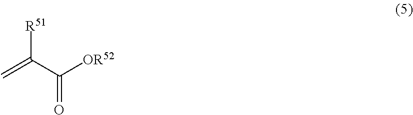

wherein R⁵¹ represents a hydrogen atom or a methyl group, and R⁵² represents a monovalent group having a reactive group.

When the curable composition further contains a compound represented by the formula (5), after the compound represented by the formula (1) and the compound represented by the formula (5) (or other compounds copolymerizable with the compound represented by the formula (1)) are polymerized, the curable composition can be additionally cured by reacting the reactive group contained in the compound represented by the formula (5) with a curing agent to be described below.

The reactive group represented by R⁵² is a group that can react with a curing agent to be described below, and is, for example, at least one group selected from the group consisting of a carboxylic group, a hydroxy group, an isocyanate group, an amino group and an epoxy group. That is, the compound represented by the formula (5) is, for example, a carboxylic group-containing compound, a hydroxy group-containing compound, an isocyanate group-containing compound, an amino group-containing compound, or an epoxy group-containing compound.

Examples of carboxylic group-containing compounds include (meth)acrylate, carboxyethyl (meth)acrylate, carboxypentyl (meth)acrylate, itaconic acid, maleic acid, fumaric acid, crotonic acid, and isocrotonic acid.

Examples of hydroxy group-containing compounds include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate; and hydroxyalkyl cycloalkane (meth)acrylates such as (4-hydroxymethylcyclohexyl)methyl (meth)acrylate. Examples of hydroxy group-containing compounds include hydroxyethyl (meth)acrylamide, allyl alcohol, 2-hydroxyethyl vinyl ether, 4-hydroxybutyl vinyl ether, and diethylene glycol monovinyl ether.

Examples of isocyanate group-containing compounds include 2-methacryloyloxyethyl isocyanate and 2-acryloyloxyethyl isocyanate.

The isocyanate group in the isocyanate group-containing compound may be blocked (protected) using a blocking agent (protecting group) that can be removed with heat. That is, the isocyanate group-containing compound may be a compound having a blocked isocyanate group represented by the following the formula (5-1).

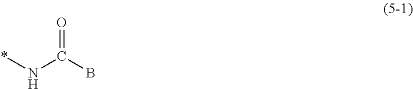

wherein B represents a protecting group, and * represents a bond.

The protecting group in the blocked isocyanate group may be a protecting group that can be removed (deprotected) with heat (for example, heating at 80 to 160° C.). In the blocked isocyanate group, a substitution reaction between the blocking agent (protecting group) and the curing agent to be described below may occur under deprotection conditions (for example, a heating condition of 80 to 160° C.). Alternatively, in the blocked isocyanate group, an isocyanate group may be generated due to deprotection, and the isocyanate group can also react with the curing agent to be described below.

Examples of blocking agents in the blocked isocyanate group include oxime compounds such as formaldoxime, acetaldoxime, acetoxime, methylethylketoxime, and cyclohexanone oxime; pyrazole compounds such as pyrazole, 3-methylpyrazole, and 3,5-dimethylpyrazole; lactam compounds such as ε-caprolactam, δ-valerolactam, γ-butyrolactam and β-propiolactam; mercaptan compounds such as thiophenol, methylthiophenol, and ethylthiophenol; acid amide compounds such as acetamide and benzamide; and imide compounds such as succinimide and maleic acid imide.

Examples of compounds having a blocked isocyanate group include 2-[(3,5-dimethylpyrazolyl)carbonylamino]ethyl methacrylate and 2-(0-[1′-methylpropylideneamino]carboxyamino)methacrylate.

Examples of amino group-containing compounds include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of epoxy group-containing compounds include glycidyl (meth)acrylate, α-ethyl glycidyl (meth)acrylate, α-n-propyl glycidyl (meth)acrylate, α-n-butyl glycidyl (meth)acrylate, 3,4-epoxy butyl (meth)acrylate, 4,5-epoxy pentyl (meth)acrylate, 6,7-epoxy heptyl (meth)acrylate, α-ethyl-6,7-epoxy heptyl (meth)acrylate, 3-methyl-3,4-epoxy butyl (meth)acrylate, 4-methyl-4,5-epoxy pentyl (meth)acrylate, 5-methyl-5,6-epoxy hexyl (meth)acrylate, O-methyl glycidyl (meth)acrylate, and α-ethyl-O-methyl glycidyl (meth)acrylate.

The content of the compound represented by the formula (5) may be, for example, 0.5 parts by mass or more, 1 part by mass or more, or 1.5 parts by mass or more and may be 10 parts by mass or less, 8 parts by mass or less, or 5 parts by mass or less with respect to 100 parts by mass of the total content of the polymerizable components.

The total content of the polymerizable components may be 30% by mass or more, 40% by mass or more, or 50% by mass or more, and may be 99% by mass or less, 90% by mass or less, 80% by mass or less, 70% by mass or less, 60% by mass or less, or 50% by mass or less, based on the total amount of the curable composition.

The compound represented by the formula (1) and the compound copolymerizable with the compound represented by the formula (1) may be selected such that the crosslinking density index calculated by the following formula (A):

Crosslinking density index=M/C×1000 (A)

wherein M represents the total number of moles (unit: mole) of polymerizable groups (ethylenically unsaturated groups) in the polymerizable component, and C represents the total content (unit: g) of the polymerizable component, falls within the range described below.

The crosslinking density index may be, for example, 2.5 or less, and from the viewpoint of obtaining a heat storage material having more excellent reliability in a high-temperature and high-humidity environment, is preferably 2.0 or less, 1.8 or less, 1.6 or less, 1.4 or less, 1.2 or less, 1.0 or less, 0.8 or less, 0.6 or less, 0.5 or less, 0.4 or less, or 0.3 or less. The crosslink density index may be, for example, 0.1 or more, 0.2 or more, or 0.3 or more.

When the curable composition contains the compound represented by the formula (5), the curable composition preferably further contains a curing agent. The curing agent is a compound that can react with a reactive group contained in the compound represented by the formula (5).

Examples of curing agents include an isocyanate curing agent, a phenolic curing agent, an amine curing agent, an imidazole curing agent, an acid anhydrate curing agent, and a carboxylic acid curing agent. One or a combination of two or more of these curing agents may be appropriately selected according to the type of the reactive group contained in the compound represented by the formula (5). For example, when the reactive group is an epoxy group, the curing agent is preferably a phenolic curing agent or an imidazole curing agent.

Examples of isocyanate curing agents include aromatic diisocyanates such as tolylene diisocyanate (2,4- or 2,6-tolylene diisocyanate, or mixtures thereof) (TDI), phenylene diisocyanate (in- or p-phenylene diisocyanate, or mixtures thereof), 4,4′-diphenyl diisocyanate, 1,5-naphthalene diisocyanate (NDI), diphenylmethane diisocyanate (4,4′-, 2,4′- or 2,2′-diphenylmethane diisocyanate, or mixtures thereof) (MDI), 4,4′-toluidine diisocyanate (TODI), 4,4′-diphenyl ether diisocyanate, xylylene diisocyanate (1,3- or 1,4-xylylene diisocyanate, or mixtures thereof) (XDI), tetramethyl xylylene diisocyanate (1,3- or 1,4-tetramethyl xylylene diisocyanate, or mixtures thereof) (TMXDI), and ω,ω′-diisocyanate-1,4-diethylbenzene.

Examples of isocyanate curing agents include aliphatic diisocyanates such as trimethylene diisocyanate, 1,2-propylene diisocyanate, butylene diisocyanate (tetramethylene diisocyanate, 1, 2-butylene diisocyanate, 2,3-butylene diisocyanate, 1,3-butylene diisocyanate), 1,5-pentamethylene diisocyanate (PDI), 1,6-hexamethylene diisocyanate (HDI), 2,4,4- or 2,2,4-trimethylhexamethylene diisocyanate, and 2,6-diisocyanate methyl caprate, and alicyclic diisocyanates such as 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate) (IPDI), methylene bis(cyclohexyl isocyanate) (4,4′-, 2,4′- or 2,2′-methylene bis(cyclohexyl isocyanate), their trans, trans-form, trans, cis-form, cis, cis-form, or mixtures thereof) (H12MDI), methyl cyclohexane diisocyanate (methyl-2,4-cyclohexane diisocyanate, methyl-2,6-cyclohexane diisocyanate), norbornane diisocyanate (various isomers or mixtures thereof) (NBDI), and bis(isocyanatomethyl)cyclohexane (1,3- or 1,4-bis(isocyanatomethyl)cyclohexane or mixtures thereof) (H6XDI).

Examples of phenolic curing agents include phenol compounds having bisphenol A, bisphenol F, bisphenol S, 4,4′-biphenylphenol, tetramethyl bisphenol A, dimethylbisphenol A, tetramethyl bisphenol F, dimethyl bisphenol F, tetramethyl bisphenol S, dimethyl bisphenol S, tetramethyl-4,4′-biphenol, dimethyl-4,4′-biphenylphenol, 1-(4-hydroxyphenyl)-2-[4-(1,1-bis-(4-hydroxyphenyl)ethyl)phenyl]propane, 2,2′-methylene-bis(4-methyl-6-tert-butylphenol), 4,4′-butylidene-bis(3-methyl-6-tert-butylphenol), trishydroxyphenylmethane, resorcinol, hydroquinone, pyrogallol, and diisopropylidene frameworks; phenol compounds having a fluorene framework such as 1,1-di-4-hydroxyphenylfluorene; cresol compounds; ethylphenol compounds; butylphenol compounds; octylphenol compounds; and various novolac resins such as novolac resins including various phenols such as bisphenol A, bisphenol F, bisphenol S, and a naphthol compound as raw materials, a phenol novolac resin containing a xylylene framework, a phenol novolac resin containing a dicyclopentadiene framework, a phenol novolac resin containing a biphenyl framework, a phenol novolac resin containing a fluorene framework, and a phenol novolac resin containing a furan framework.

Examples of amine curing agents include aromatic amines such as diaminodiphenylmethane, diaminodiphenyl sulfone, diaminodiphenyl ether, p-phenylenediamine, m-phenylenediamine, o-phenylenediamine, 1,5-diaminonaphthalene, and m-xylylenediamine, and aliphatic amines such as ethylenediamine, diethylenediamine, hexamethylenediamine, isophorone diamine, bis(4-amino-3-methyldicyclohexyl)methane, and polyether diamine; and guanidine compounds such as dicyandiamide, and 1-(o-tolyl)biguanide.

Examples of imidazole curing agents include 2-methylimidazole, 2-ethyl-4-methylimidazole, 2-phenylimidazole, 2-undecylimidazole, 2-heptadecylimidazole, 2-phenyl-4-methylimidazole, 1-benzyl-2-phenylimidazole, 1-benzyl-2-methylimidazole, 1-cyanoethyl-2-methylimidazole, 1-cyanoethyl-2-phenylimidazole, 1-cyanoethyl-2-undecylimidazole, 2,3-dihydro-1H-pyrrolo-[1,2-a]benzimidazole, 2,4-diamino-6(2′-methylimidazole(1′))ethyl-s-triazine, 2,4-diamino-6(2′-undecylimidazole(1′))ethyl-s-triazine, 2,4-diamino-6(2′-ethyl-4-methylimidazole(1′))ethyl-s-triazine, 2,4-diamino-6(2′-methylimidazole(1′))ethyl-s-triazineisocyanuric acid adducts, 2-methylimidazole isocyanuric acid adducts, 2-phenylimidazole isocyanuric acid adducts, 2-phenyl-3,5-dihydroxymethylimidazole, 2-phenyl-4-methyl-5-hydroxymethylimidazole, and 1-cyanoethyl-2-phenyl-3,5-dicyanoethoxymethylimidazole.

Examples of acid anhydride curing agents include aromatic carboxylic anhydrides such as phthalic anhydride, trimellitic anhydride, pyromellitic anhydride, benzophenone tetracarboxylic acid anhydride, ethylene glycol trimellitic anhydride, and biphenyl tetracarboxylic acid anhydride; anhydrides of aliphatic carboxylic acids such as azelaic acid, sebacic acid, and dodecanedioic acid, and alicyclic carboxylic acid anhydrides such as tetrahydrophthalic anhydride, hexahydrophthalic anhydride, nadic anhydride, HET anhydride, and himic anhydride.

Examples of carboxylic acid curing agents include succinic acid, glutaric acid, adipic acid, sebacic acid, phthalic acid, isophthalic acid, and terephthalic acid.

The content of the curing agent may be 0.01% by mass or more, 10% by mass or less, 5% by mass or less, or 1% by mass or less, based on the total amount of the curable composition.

From the viewpoint of obtaining a heat storage material having more excellent heat storage capacity, preferably, the curable composition may further contain a heat storage capsule. The heat storage capsule has a heat storage component and an outer shell (shell) containing the heat storage component.

As the heat storage component in the heat storage capsule, for example, a component having a phase transition temperature that matches a target temperature is appropriately selected according to the purpose of use. From the viewpoint of obtaining a heat storage effect in a practical range, the other heat storage component has, for example, a solid phase/liquid phase transition point (melting point) exhibiting phase transition of a solid phase/liquid phase at −30 to 120° C.

The other heat storage component may be, for example, a chain-like (linear or branched (branched chain-like)) saturated hydrocarbon compound (paraffin hydrocarbon compound), natural wax, petroleum wax, or a sugar alcohol. The other heat storage component is preferably a chain-like saturated hydrocarbon compound (paraffin hydrocarbon compound) because it is inexpensive and has low toxicity and it is possible to easily select one having a desired phase transition temperature.

Specific examples of chain-like saturated hydrocarbon compounds include n-decane (C10 (number of carbon atoms, the same applies hereinafter), −29° C. (transition point (melting point), the same applies hereinafter)), n-undecane (C11, −25° C.), n-dodecane (C12, −9° C.), n-tridecane (C13, −5° C.), n-tetradecane (C14, 6° C.), n-pentadecane (C15, 9° C.), n-hexadecane (C16, 18° C.), n-heptadecane (C17, 21° C.), n-octadecane (C18, 28° C.), n-nanodecane (C19, 32° C.), n-eicosane (C20, 37° C.), n-heneicosane (C21, 41° C.), n-docosane (C22, 46° C.), n-tricosane (C23, 47° C.), n-tetracosane (C24, 50° C.), n-pentacosane (C25, 54° C.), n-hexacosane (C26, 56° C.), n-heptacosane (C27, 60° C.), n-octacosane (C28, 65° C.), n-nonacosane (C29, 66° C.), n-triacontane (C30, 67° C.), n-tetracontane (C40, 81° C.), n-pentacontane (C50, 91° C.), n-hexacontane (C60, 98° C.), and n-hectane (C100, 115° C.). The chain-like saturated hydrocarbon compound may be a branched saturated hydrocarbon compound having the same number of carbon atoms as these linear saturated hydrocarbon compounds, and chain-like saturated hydrocarbon compounds may be of one type or of two or more types.

The outer shell (shell) containing such a heat storage component is preferably formed of a material having a heat resistance temperature sufficiently higher than the transition point (melting point) of the heat storage component. The material forming the outer shell has a heat resistance temperature that is, for example, 30° C. or higher, and preferably 50° C. or higher, with respect to the transition point (melting point) of the heat storage component. Here, the heat resistance temperature is defined as a temperature at which 1% weight loss occurs when the weight loss of the capsule is measured using a differential thermogravimetric simultaneous measurement device (for example, TG-DTA6300, manufactured by Hitachi High-Tech Science Corporation)).

As the material forming the outer shell, a material having a strength according to the application of the heat storage material formed of the curable composition is appropriately selected. The outer shell is preferably formed of a melamine resin, an acrylic resin, a urethane resin, silica, or the like. Examples of micro capsules having an outer shell containing a melamine resin include BA410xxP, 6C, BA410xxP, 18C, BA410xxP, and 37C (manufactured by Outlast Technology LLC), Thermo Memory FP-16, FP-25, FP-31, and FP-39 (manufactured by Mitsubishi Paper Mills Ltd.), and Riken Resin PMCD-15SP, 25SP, and 32SP (manufactured by Mikiriken Industrial Co., Ltd.). Examples of micro capsules having an outer shell containing an acrylic resin (polymethyl methacrylate resin) include MicronalDS5001X, 5040X (manufactured by IGM Resins B.V.). Examples of micro capsules having an outer shell containing silica include Riken Resin LA-15, LA-25, and LA-32 (manufactured by Mikiriken Industrial Co., Ltd.).

The content of the heat storage component in the heat storage capsule, with respect to a total amount of the heat storage capsule, is preferably 20% by mass or more, and more preferably 60% by mass or more, from the viewpoint of further improving the heat storage effect, and is preferably 80% by mass or less from the viewpoint of inhibiting breakage of the capsule due to change in the volume of the heat storage component.

The heat storage capsule may further contain graphite, a metal powder, an alcohol or the like in the outer shell to adjust the thermal conductivity of the capsule, a specific gravity, or the like.

The particle size (average particle size) of the heat storage capsule is preferably 0.1 μm or more, more preferably 0.2 μm or more, and still more preferably 0.5 μm or more, and preferably 100 μm or less, and more preferably 50 μm or less. The particle size (average particle size) of the heat storage capsule is measured using a laser diffraction particle size distribution measuring device (for example, SALD-2300 manufactured by Shimadzu Corporation).

From the viewpoint of further improving the heat storage effect, the content of the heat storage capsule is preferably 20% by mass or more, more preferably 30% by mass or more, and still more preferably 40% by mass or more, based on the total amount of the curable composition. From the viewpoint of to preventing the heat storage capsule from dropping out of a cured product of the curable composition, the content of the heat storage capsule is preferably 90% by mass or less, more preferably 85% by mass or less, and still more preferably 80% by mass or less, based on the total amount of the curable composition.

From the viewpoint of improving thermal reliability of a cured product (heat storage material) of the curable composition, the curable composition may further contain an antioxidant. The antioxidant may be, for example, a phenolic antioxidant, a benzophenone antioxidant, a benzoate antioxidant, a hindered amine antioxidant, or a benzotriazole antioxidant.

The content of the antioxidant, based on the total amount of the curable composition, may be 0.1% by mass or more, 0.5% by mass or more, 0.8% by mass or more, or 1% by mass or more and may be 10% by mass or less or 5% by mass or less, and from the viewpoint of obtaining excellent flexibility of a cured product of the curable composition, the content is preferably 4% by mass or less, more preferably 3% by mass or less, still more preferably 2.5% by mass or less, and particularly preferably 2% by mass or less.

The curable composition may further contain other additives as necessary. Examples of other additives include a surface treatment agent, a curing accelerator, a colorant, a filler, a crystal nucleating agent, a heat stabilizer, a thermal conductive material, a plasticizer, a foaming agent, a flame retardant, a damping agent, a dehydrating agent, and a flame retardant aid (for example, a metal oxide). These other additives may be used alone or two or more thereof may be used in combination. The content of other additives may be 0.1% by mass or more or 30% by mass or less based on the total amount of the curable composition.

The curable composition may be a liquid at 50° C. Thus, the curable composition can be easily provided between members having a complicated shape by a method such as filling. In this case, from the viewpoint of obtaining excellent flowability and handling properties, the viscosity of the curable composition at 50° C. is preferably 100 Pas or less, more preferably 50 Pas or less, still more preferably 20 Pas or less, and particularly preferably 10 Pas or less, and may be, for example, 0.5 Pas or more. The viscosity of the curable composition is a value measured based on JIS Z 8803, and specifically, a value measured by an E type viscometer (for example, manufactured by Toki Sangyo Co., Ltd., PE-80L). Here, the viscometer can be calibrated based on JIS Z 8809-JS14000.

In the curable composition described above, a heat storage material having excellent reliability in a high-temperature and high-humidity environment can be formed by using a combination of a compound represented by the formula (1) which has two (meth)acryloyl groups, and a compound obtained by etherifying a hydroxyl group at at least one terminal of polyalkylene glycol. The reason for this is presumed to be that when the curable composition is cured, the polyalkylene glycol ether having improved reliability in a high-temperature and high-humidity environment due to the terminal hydroxyl group being etherified is successfully incorporated into the crosslinked structure formed from the compound represented by the formula (1), and thus the resistance to external moisture is improved by the synergistic effect of these. In addition, the cured product of the curable composition may have an excellent heat storage amount due to the compound represented by the formula (1) and the polyoxyalkylene chain in the polyalkylene glycol ether. Therefore, the curable composition is suitable as a curable composition used for forming a heat storage material, and a cured product of the curable composition is suitable as a heat storage material.

[Heat Storage Material]

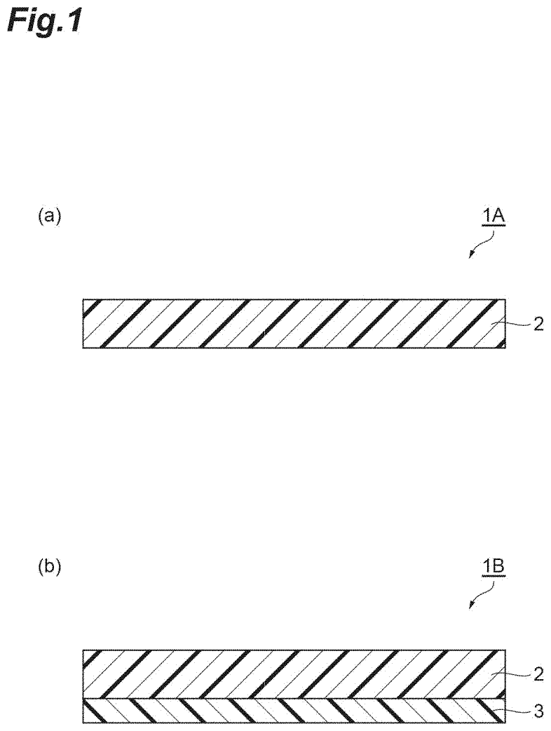

The heat storage material according to one embodiment contains the above cured product of the curable composition. FIG. 1 is a schematic cross-sectional view showing a heat storage material according to one embodiment. As shown in view (a) of FIG. 1, a heat storage material 1A according to one embodiment is a sheet-like (or film-like) heat storage material having a heat storage layer 2 which is a cured product of the above curable composition.

As shown in view (b) of FIG. 1, a heat storage material 1B according to another embodiment is a sheet-like (or film-like) heat storage material including the heat storage layer 2 which is a cured product of the above curable composition and an adhesive layer 3 provided on one surface of the heat storage layer 2. In this case, the heat storage material 1B can be suitably adhered to an application target of the heat storage material 1B.

In the above embodiments, the thickness of the heat storage layer 2 may be, for example, 0.01 mm or more, 0.05 mm or more, 0.1 mm or more, or 0.2 mm or more, and may be 20 mm or less, 10 mm or less, or 5 mm or less.

In the above embodiments, the heat storage layer 2 may be a cured product in which the curable composition is completely cured, or may be a cured product in which the curable composition is converted into the B stage (semi-cured). In the heat storage material 1A shown in view (a) of FIG. 1, from the viewpoint of suitably adhering the heat storage material 1A to an application target of the heat storage material 1A, the heat storage layer 2 is preferably a cured product in which the curable composition is converted into the B stage (semi-cured).

The adhesive layer 3 may be composed of a known adhesive. The thickness of the adhesive layer 3 may be, for example, 0.001 mm or more, 0.003 mm or more, or 0.005 mm or more, or may be 0.03 mm or less, 0.02 mm or less, or 0.015 mm or less.

The heat storage materials 1A and 1B (collectively referred to as the heat storage material 1) can be used in various fields. The heat storage material 1 is used for, for example, air conditioning devices (for improving efficiency of air conditioning devices) in automobiles, buildings, public facilities, underground malls, and the like, pipes (for heat storage of pipes) in factories and the like, engines (for heat retention around the engine) in automobiles, electronic components (for preventing increasing of the temperature of electronic components), fibers for undergarments, and the like.

The heat storage layer 2 in the heat storage material 1A or the heat storage layer 2 and the adhesive layer 3 in the heat storage material 1B described above may be provided on a support film. That is, a heat storage material according to another embodiment may include a support film and a heat storage layer 2 provided on the support film. The heat storage material according to another embodiment may include a support film, a heat storage layer 2 provided on the support film, and an adhesive layer 3 provided on the side opposite to the support film of the heat storage layer 2. The heat storage materials according to these embodiments may be, for example, formed in a long shape and wound around a winding core in the longitudinal direction (roll-shaped heat storage material).

The support film may be formed of a polymer, for example, polyethylene terephthalate, polyethylene, polyvinylidene chloride, polyester, plypropylene, polyvinyl chloride, polycarbonate, polyacrylonitrile, polyetheretherketone, polyvinyl alcohol, ethylene-vinyl alcohol copolymer, polyimide, or polyamide-imide.

The thickness of the support film may be, for example, 10 μm or more, 30 μm or more, or 50 μm or more, and may be 200 μm or less, 150 μm or less, 100 μm or less, 70 μm or less, or 50 μm or less.

[Article and Method of Producing the Same]

Next, regarding an article including the heat storage material 1 (a cured product of the curable composition) and a method of producing the same, an electronic component will be exemplified as an object in which the heat storage material 1 is provided.

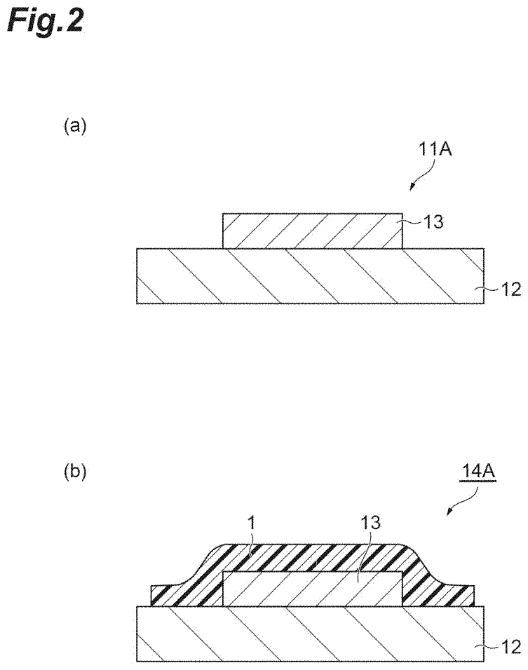

FIG. 2 is a schematic cross-sectional view showing an article and a method of producing the same according to one embodiment. In the method of producing an article according to one embodiment, first, as shown in view (a) of FIG. 2, an electronic component 11A is prepared as an article as an object in which the heat storage material is provided. The electronic component 11A includes, for example, a substrate 12 and a semiconductor chip (heat source) 13 provided on the substrate 12.

Next, as shown in view (b) of FIG. 2, the sheet-like heat storage material 1 is disposed on the substrate 12 and the semiconductor chip 13 so that it is in thermal contact with the substrate 12 and the semiconductor chip 13. The heat storage material 1 may be, for example, the heat storage material 1A shown in view (a) of FIG. 1 described above or the heat storage material 1B shown in view (b) of FIG. 1 described above. When the heat storage material 1B shown in view (b) of FIG. 1 is used, the heat storage material 1B is disposed so that the adhesive layer 3 is in contact with the substrate 12 and the semiconductor chip 13.

When the heat storage layer in the heat storage material 1 is a cured product in which the curable composition is converted into the B stage (semi-cured), the heat storage layer is cured after the heat storage material 1 is disposed. That is, the method of producing an article according to the present embodiment may further include a process of curing the heat storage layer of the heat storage material 1 disposed on the substrate 12 and the semiconductor chip 13.

Thereby, an article 14A including the substrate 12, the semiconductor chip 13, and the heat storage material 1 (a cured product of the curable composition) provided on the substrate 12 and the semiconductor chip 13 is obtained.

In the above embodiment, the heat storage material 1 is disposed so that it covers the entire exposed surface of a heat source 13, but in another embodiment, the heat storage material may be disposed so that it covers a part of the exposed surface of the heat source.

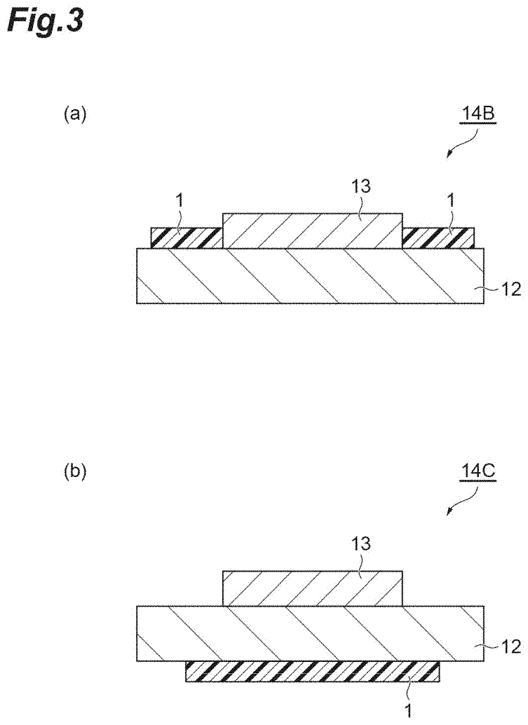

View (a) of FIG. 3 is a schematic cross-sectional view showing an article according to another embodiment. As shown in view (a) of FIG. 3, in an article 14B according to another embodiment, for example, the heat storage material 1 may be disposed so that it is in contact with a part (covers a part) of the exposed surface of the semiconductor chip (heat source) 13. While a part in which the heat storage material 1 is disposed (a part of the heat storage material 1 in contact with the semiconductor chip 13) is a side part of the semiconductor chip 13 in view (a) of FIG. 3, the part may be any surface of the semiconductor chip 13.

View (b) of FIG. 3 is a schematic cross-sectional view showing an article according to another embodiment. As shown in view (b) of FIG. 3, in an article 14C according to another embodiment, the heat storage material 1 is disposed on the surface opposite to the surface of the substrate 12 on which the semiconductor chip 13 is provided. In the present embodiment, the heat storage material 1 is not in direct contact with the semiconductor chip 13, but is in thermal contact with the semiconductor chip 13 with the substrate 12 therebetween. A part in which the heat storage material 1 is disposed may be any surface of the substrate 12 as long as it is in thermal contact with the semiconductor chip 13. In this case, heat generated in the heat source (semiconductor chip) 13 is efficiently conducted to the heat storage material 1 with the substrate 12 therebetween, and suitably stored in the heat storage material 1.

In the production method according to the above embodiment, the heat storage material 1 is in the form of sheet, but in a production method according to another embodiment, it is possible to produce an article using a liquid curable composition (a heat storage material is formed).

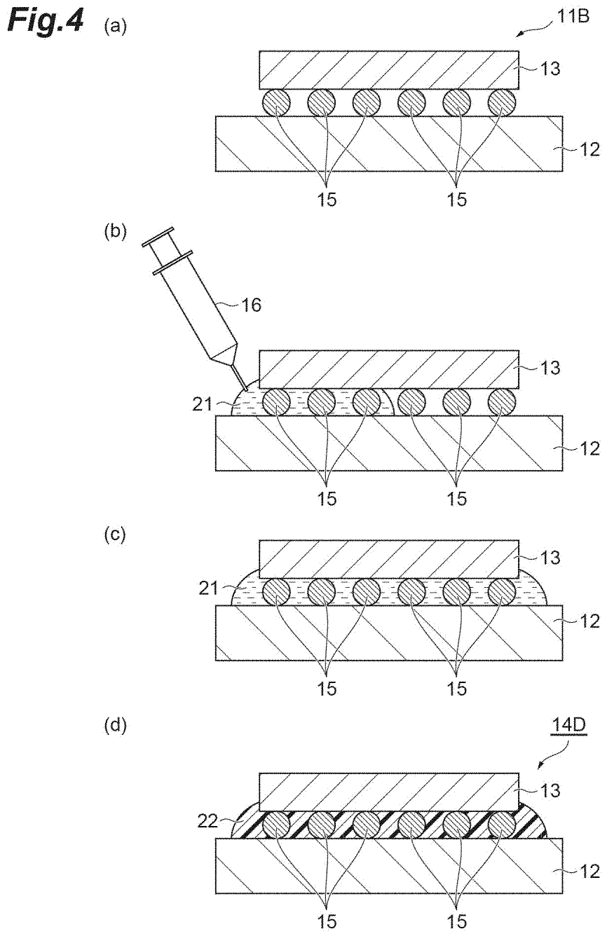

FIG. 4 is a schematic cross-sectional view showing a method of producing an article according to another embodiment. In the production method according to the present embodiment, first, as shown in view (a) of FIG. 4, an electronic component 11B is prepared as an article as an object in which the heat storage material is provided. The electronic component 11B includes, for example, the substrate (for example, circuit board) 12, the semiconductor chip (heat source) 13 provided on the substrate 12, and a plurality of connecting parts (for example, solders) 15 that connect the semiconductor chip 13 to the substrate 12. The plurality of connecting parts 15 are provided between the substrate 12 and the semiconductor chip 13 so that they are separated from each other. That is, there are gaps between the substrate 12 and the semiconductor chip 13 so that the plurality of connecting parts 15 are separated from each other.

Next, as shown in view (b) of FIG. 4, for example, a curable composition 21 is filled between the substrate 12 and the semiconductor chip 13 using a syringe 16. The curable composition 21 is the curable composition according to the above embodiment. The curable composition 21 may be in a completely uncured state or in a partially cured state.

When the curable composition 21 is in a liquid state at room temperature (for example, 25° C.), the curable composition 21 can be filled at room temperature. When the curable composition 21 has a solid form at room temperature, the curable composition 21 can be heated at (for example, 50° C. or higher) and changed to a liquid state, and then filled.

When the curable composition 21 is filled as described above, as shown in view (c) of FIG. 4, the curable composition 21 is disposed in the above gap between the substrate 12 and the semiconductor chip 13 so that it is in thermal contact with the substrate 12, the semiconductor chip 13 and the connecting part 15.

Next, when the curable composition 21 is cured, as shown in view (d) of FIG. 4, a cured product 22 (can also be called a heat storage layer or a heat storage material) of the curable composition is formed in the above gap between the substrate 12 and the semiconductor chip 13. In this manner, an article 14D including the substrate 12, the semiconductor chip (heat source) 13 provided on the substrate 12, the plurality of connecting parts 15 that connect the semiconductor chip 13 to the substrate 12, and the cured product (the heat storage layer or the heat storage material) 22 of the curable composition that is provided so that it fills gaps formed by the substrate 12, the semiconductor chip (heat source) 13 and the plurality of connecting parts 15 is obtained.

A method of curing the curable composition 21 may be a method of curing the curable composition 21 by heating the disposed curable composition 21 when the curable composition 21 contains a thermal polymerization initiator. The method of curing the curable composition 21 may be a method of curing the curable composition 21 by emitting light (for example, light having at least a part of wavelengths of 200 to 400 nm (ultraviolet light)) to the curable composition 21 when the curable composition 21 contains a photopolymerization initiator. The curing method may be a combination of one or two or more of these methods.

In the above embodiments, the heat storage material 1 (the cured product 22 of the curable composition) is disposed so that it is in direct contact with the semiconductor chip 13 as a heat source, but the heat storage material and the cured product of the curable composition simply need to be in thermal contact with the heat source, and in another embodiment, for example, it may be disposed so that it is in thermal contact with the heat source with a thermally conductive member (such as a heat dissipation member) therebetween.

### EXAMPLES

While the present invention will be described below in more detail with reference to examples, the present invention is not limited to the following examples.

[Synthesis of Compound (A-1)]

A 500 mL flask including a stirrer, a thermometer, a nitrogen gas inlet pipe, a discharge pipe and a heating jacket was used as a reaction container, 15 g of polyethylene glycol #1000 (weight average molecular weight: 1,000, manufactured by Sanyo Chemical Industries, Ltd.), and 300.0 g of toluene were put into the reaction container, and stirred at 45° C. and a stirring rotation rate of 250 rpm, nitrogen was caused to flow at 100 mL/min, and stirring was performed for 30 minutes. Then, the temperature was lowered to 25° C., and after the temperature lowering was completed, 2.9 g of acryloyl chloride was added dropwise to the reaction container, and the mixture was stirred for 30 minutes. Then, 3.8 g of trimethylamine was added dropwise and the mixture was stirred for 2 hours. Then, the temperature was raised to 45° C., and reacted for 2 hours. The reaction solution was filtered, and the filtrate was desolubilized to obtain a compound (A-1) represented by the following the formula (1-3) and having a weight average molecular weight of 1,000.

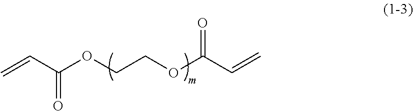

[Synthesis of Compound (A-2)]

A compound (A-2) represented by the formula (1-3) and having a weight average molecular weight of 3,400 was obtained in the same manner as in the compound (A-1) except that 45 g of polyethylene glycol 4,000 (weight average molecular weight: 2,700 to 3,300, manufactured by Fujifilm Wako Pure Chemical Corporation Co., Ltd.) was used instead of 15 g of polyethylene glycol #1000.

[Synthesis of Compound (A-3)]

A compound (A-3) represented by the formula (1-3) and having a weight average molecular weight of 8,000 was obtained in the same manner as in the compound (A-1) except that 120 g of polyethylene glycol 6,000 (weight average molecular weight: 7,300 to 9,300, manufactured by Fujifilm Wako Pure Chemical Corporation Co., Ltd.) was used instead of 15 g of polyethylene glycol #1000.

In the Examples, the following components were used in addition to the compounds (A-1) to (A-3).
(B-1) polyethylene glycol monomethyl ether (weight average molecular weight: 1,000)
(B-2) polyethylene glycol dimethyl ether (weight average molecular weight: 1,000)
(B-3) polyethylene glycol monomethyl ether (weight average molecular weight: 4,000)
(b-1) polyethylene glycol (weight average molecular weight: 1,000)
(C-1) methoxypolyethylene glycol acrylate (weight average molecular weight: 550)
(C-2) methoxypolyethylene glycol acrylate (weight average molecular weight: 1,000)
(D-1) antioxidant (ADK STAB AO-80, manufactured by Adeka Corporation)
(D-2) polymerization initiator (Omnirad 1173, manufactured by IGM Resins B.V.)

[Production of Heat Storage Material]

The components were heated and mixed at 70° C. in the proportions shown in Tables 1 and 2 to obtain each curable composition of Examples and Reference Examples. Next, under the condition of 70° C., using a spacer, the curable composition was coated on a PET film so that the thickness after curing was 200 μm, and the coated surface was covered with the same PET film. This was irradiated with UV light using a metal halide lamp manufactured by Ushio Inc. such that the irradiance was 130 mW/cm² and the integrated light amount was 4000 mJ/cm² or more, thereby obtaining a heat storage material (cured product of the curable composition).

[Reliability Test in High-Temperature and High-Humidity Environment]

Three samples each having a size of 30 mm×30 mm were cut out from each heat storage material (cured product) of Examples and Reference Examples, and the weight (initial weight) of each sample was measured. These samples were left to stand for 1 hour in an environment of a temperature of 85° C. and a humidity of 85% RH. When the surface of each sample after standing was visually observed, exudation of the liquid component was observed on the surfaces of the samples of Reference Example 1 and Examples 1 to 2, 4 to 5, and 9. The liquid components on the surfaces of these samples in which bleeding was confirmed were wiped off with a Kimwipe (manufactured by Nippon Paper Crecia Co., Ltd.), and the weight of each of the three samples (weight after test) was measured. With respect to the weight change rate obtained by the following formula, an average value of three samples was calculated.

Weight change rate (%)=(weight after test−initial weight)/initial weight×100

In addition, with respect to the samples of the remaining examples in which bleeding of the liquid component was not confirmed, the weight (weight after test) of each of the three samples was measured, and the average value of the three samples was calculated with respect to the weight change rate obtained by the above formula. The weight change rates calculated as described above are shown in Tables 1 and 2.

[Measurement of Heat Storage Amount]

For each heat storage material (cured product) of the Examples, the heat storage amount was calculated by measurement using a differential scanning calorimeter (manufactured by TA Instruments, model number Discovery DSC250). Specifically, the thermal behavior of each heat storage material was measured by raising the temperature to 100° C. at a rate of 20° C./min, holding the temperature at 100° C. for 3 minutes, lowering the temperature to −20° C. at a rate of 3° C./min, holding the temperature at −20° C. for 3 minutes, and raising the temperature again 10 to 100° C. at a rate of 3° C./min. The area of the melting peak was calculated as the amount of heat storage. The results are shown in Tables 1 and 2.

TABLE 1

| | | Reference | Example | Example | Example | Example | Example | Example |
|---|---|---|---|---|---|---|---|---|
| | | Example 1 | 1 | 2 | 3 | 4 | 5 | 6 |
| Content | A-1 | 50.0 | 50.0 | — | — | 50.0 | — | — |
| (parts by | A-2 | — | — | 50.0 | — | — | 50.0 | — |
| mass) | A-3 | — | — | — | 50.0 | — | — | 50.0 |
| | B-1 | — | 50.0 | 50.0 | 50.0 | — | — | — |
| | B-2 | — | — | — | — | 50.0 | 50.0 | 50.0 |
| | b-1 | 50.0 | — | — | — | — | — | — |
| | D-1 | 2.5 | 2.5 | 2.5 | 2.5 | 2.5 | 2.5 | 2.5 |
| | D-2 | 0.4 | 0.4 | 0.4 | 0.4 | 0.4 | 0.4 | 0.4 |

| | | | | | | | |
|---|---|---|---|---|---|---|---|
| Crosslinking density | 2.0 | 2.0 | 0.6 | 0.3 | 2.0 | 0.6 | 0.3 |
| index | | | | | | | |
| Weight change rate (%) | −10.4 | −8.6 | −2.2 | 2.6 | −10.0 | −1.1 | 1.4 |
| Heat storage amount | — | 73.8 | 118.0 | 134.2 | 75.9 | 119.0 | 140.7 |
| (J/g) | | | | | | | |

TABLE 2

| | | Example 7 | Example 8 | Example 9 | Example 10 | Example 11 | Example 12 | Example 13 |
|---|---|---|---|---|---|---|---|---|
| Content | A-1 | 50.0 | 12.5 | 25.0 | — | 10.0 | 7.5 | 5.0 |
| (parts by | A-2 | — | — | — | 16.7 | — | — | — |
| mass) | A-3 | — | 12.5 | — | — | 10.0 | 7.5 | 5.0 |
| | B-1 | — | 50.0 | — | — | 60.0 | 70.0 | 80.0 |
| | B-2 | — | — | 50.0 | 50.0 | — | — | — |
| | B-3 | 50.0 | — | — | | — | — | — |
| | C-1 | — | — | — | 22.2 | — | — | — |
| | C-2 | — | 25.0 | 25.0 | 11.1 | 20.0 | 15.0 | 10.0 |
| | D-1 | 2.5 | 2.5 | 2.5 | 2.5 | 2.5 | 2.5 | 2.5 |
| | D-2 | 0.4 | 0.4 | 0.4 | 0.4 | 0.4 | 0.4 | 0.4 |

| | | | | | | | |
|---|---|---|---|---|---|---|---|
| Crosslinking density | 2.0 | 1.1 | 1.5 | 1.2 | 1.1 | 1.1 | 1.1 |
| index | | | | | | | |
| Weight change rate | 2.5 | 3.6 | −1.8 | 1.5 | 2.1 | 3.5 | 2.0 |
| (%) | | | | | | | |
| Heat storage | 84.6 | 116.6 | 108.5 | 120.0 | 122.5 | 131.8 | 135.9 |
| amount (J/g) | | | | | | | |

When the weight change rate was a negative value, it means that the liquid component exuded to the sample surface, and in this case, the larger the absolute value, the larger the amount of exuded. The liquid component is considered to be polyethylene glycol or polyethylene glycol ether. On the other hand, when the weight change rate was a positive value, it is considered that the liquid component did not exude to the sample surface, and the heat storage material absorbed and contained moisture under a high-temperature and high-humidity environment. That is, it can be said that the reliability under high-temperature and high-humidity is more excellent when the weight change rate was a positive value than when the weight change rate was a negative value, and it can be said that the reliability under high-temperature and high-humidity was more excellent when the absolute value thereof was small when the weight change rate was a negative value. As can be seen from Tables 1 and 2, Examples 1 to 13 in which the compound represented by the formula (1) and the polyalkylene glycol ether were used in combination exhibited better reliability under the high-temperature and high-humidity condition than Reference Example 1 in which the compound represented by the formula (1) and the polyalkylene glycol were used in combination.

### REFERENCE SIGNS LIST

1, 1A, 1B: heat storage material, 2: heat storage layer, 3: adhesive layer, 11A, 11B: electronic component, 12: substrate, 13: semiconductor chip (heat source), 14A, 14B, 14C, 14D: article, 15: connecting part, 16: syringe, 21: curable composition, 22: cured product of curable composition (heat storage material).

1. A curable composition comprising:
a compound represented by the following formula (1): 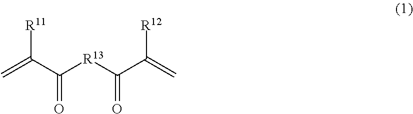
wherein R¹¹ and R¹² each independently represent a hydrogen atom or a methyl group, and Rn represents a divalent group having a polyoxyalkylene chain; and
at least one polyalkylene glycol ether selected from the group consisting of a polyalkylene glycol monoether and a polyalkylene glycol diether.

2. The curable composition according to claim 1, comprising a compound having a weight average molecular weight of 1,000 or more and represented by the formula (1), as the compound represented by the formula (1).

3. The curable composition according to claim 1, comprising a polyalkylene glycol ether having a weight average molecular weight of 400 or more as the polyalkylene glycol ether.

4. The curable composition according to claim 1, comprising a polyalkylene glycol ether having a weight average molecular weight of 5,000 or less as the polyalkylene glycol ether.

5. The curable composition according to claim 1, further comprising a compound represented by the following formula (3): 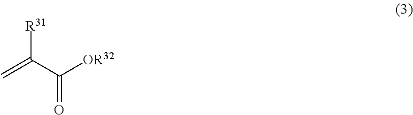
wherein R₃₁ represents a hydrogen atom or a methyl group, and R³² represents a monovalent group having a polyoxyalkylene chain.

6. The curable composition according to claim 1, being used for forming a heat storage material.

7. A heat storage material comprising a cured product of the curable composition according to claim 1.

8. An article comprising:
a heat source; and
a cured product of the curable composition according to claim 1, the cured product being provided to be thermally in contact with the heat source.
